(19) United States
(12) Patent Application Publication
(10) Pub. No.: US 2001/0047516 A1
(43) Pub. Date: Nov. 29, 2001

(54) System for time shifting live streamed video-audio distributed via the internet

(75) Inventors: Michael J. Swain, Newton, MA (US); Christopher M. Weikart, West Newton, MA (US); Jean-Manuel Van Thong, Arlington, MA (US)

Correspondence Address: Mary Lou Wakimura, Esq., HAMILTON, BROOK, SMITH & REYNOLDS, P.C., Two Militia Drive, Lexington, MA, 02421-4799, US

(73) Assignee: Compaq Computer Corporation, Houston, TX (US)

(21) Appl. No.: 09/773,332

(22) Filed: Jan. 31, 2001

Related U.S. Application Data
(60) Provisional application No. 60/178,964, filed on Feb. 1, 2000.

(51) Int. Cl. H04N 7/173

(52) U.S. Cl. 725/86; 725/87; 725/91

(57) ABSTRACT

The invention is a system for time shifting live, streamed video and/or audio distributed via a global computer network, e.g., the Internet. The invention is preferably implemented as client-server software, with the possibility of both the client and the server running on the same PC. Alternatively, the system software may be embedded within a digital VCR information appliance, giving the system the ability to time shift and display Internet content as well as broadcast video content received via cable or satellite.

### RELATED APPLICATIONS

This application is claims the benefit of U.S. Provisional Application No. 60/178,964 filed Feb. 1, 2000, the entire teachings of which are incorporated herein by reference.

### BACKGROUND OF THE INVENTION

With the advent of streaming multimedia technology from RealNetworks and, more recently, Microsoft, live broadcast multimedia has begun to proliferate on the Internet. There are already a large number of live events that are broadcast on the Internet—see Broadcast.com for a number of examples (http:/www.broadcast.com/live/ daysched.asp). Other calendars of live webcasts can be found at Yahoo! Net Events (http://events.yahoo.corn/) and OnNow.com (http://www.onnow.com). These events typically fall into a wide range of subject categories: sports, entertainment, news, health, computers, business and others.

In some cases, archived versions of live webcast (i.e., Internet provided broadcast multimedia) content do not exist. Broadcast.com does not archive the Rush Limbaugh show, its most popular radio talk show. While many live events are archived, finding where they are is not always easy—for example, there is no link from Broadcast.com's live schedule to archives. Another example is regular season baseball games, which can be found at http://www. majorleaguebaseball.com/. They are not archived at the Major League Baseball site, though they are archived at http://espn.go.com.

Even when archived versions may exist, there are other reasons why users will want time shifted (i.e., at a time other than the live broadcast) video and audio broadcasts. For example, there is invariably a lag between the live broadcast of an event and the appearance of an archived version, at least for the duration of the event. So, time shifting could be of value for similar reasons to those given for TV versions of such products as ReplayTV (http://www.replaytv.com) and TiVo (http://www.tivo.com).

to pause a live event because of an interruption,

to avoid commercials, intermissions or other unwanted parts of the broadcast, by using features that allow the user to fast-forward or jump ahead in the broadcast,

to be able to start viewing the broadcast from the beginning when arriving late,

to rewind and review portions of the broadcast while viewing it.

Some live events are extremely popular, such as the Victoria's Secret live webcast of its fashion show on Feb. 3, 1999 webcast by Broadcast.com. According to Broadcast.com, 1.5 million viewers watched the event (see http://www.cnnfn.com/ digitaljam/9902 04/victoria/) which was marred by technical difficulties (see “Net video not ready for prime time” http://www.news.com/News/Item/0,4,32033,00.html). The number of live events will increase as Internet Protocol multicast technologies are more widely deployed—these were not in place for the Victoria's Secret webcast, and their absence was blamed for many of the problems encountered. With IP multicast, it will be considerably less expensive to transmit video and audio during live broadcasts than to transmit them on demand, especially for high quality video.

One further advantage particular to the use of time-shifting technology for the Internet would be that pauses for re-buffering due to network congestion could be avoided.

Prior approaches include the time-shifting systems of TiVo and ReplayTV, both of which capture analog TV signals as MPEG2 digital streams that are saved to disk. These systems are both self-contained information appliances, physical devices that receive an analog television-format video feed and produce the same format of feed, time shifted, for display on a television. The DISHPlayer Satellite Receiver for the DISH Network satellite service (http:/www.webtv.com/products/satellite/) performs time shifting on video received from the service, presumably by saving MPEG2 streams from a digital satellite service to a buffer on disk.

A patent was awarded in 1993 (U.S. Pat. No. 5,241,428) for a variable-delay video recorder, and in 1997 (U.S. Pat. No. 5,701,383) for a video time-shifting apparatus. Both of these devices are self-contained hardware devices, similar in this way to the ReplayTV and TiVo products.

### SUMMARY OF THE INVENTION

The present invention provides a system for time shifting live streamed, video/audio data distributed via the Internet and solves the problems of the prior art. The invention system stores audio and video (i.e., multimedia) on disk, allowing users to time shift and replay originally live, streamed broadcast content on the Internet. The preferred embodiment uses a client-server architecture, allowing one cache to be shared among multiple clients. With a service delivered through a Web site that lists upcoming live events, the present invention allows users to select events of interest and arrange for them to be recorded.

As such the present invention (i) captures video and audio (i.e., multimedia) content streamed over the Internet, instead of capturing Broadcast TV; (ii) is a software application, combined with a service delivered from a Web site, instead of a physical device as in the prior art hardware devices; and (iii) may serve a number of different users sharing one cache of archived material, with of its client-server design.

In a preferred method and apparatus of the present invention, operation is in a global computer network in which at least one node broadcasts live events over the network. The invention apparatus and method provides to a user, contents of desired ones of the broadcasts shifted in time. The invention apparatus includes a user interface, a working server and a video-audio output means. The user interface enables the user to form a request for the contents of a future broadcast of a live event. The request includes date, time and network location of the subject broadcast.

The working server is coupled to the user interface and receives the user requests. The working server responds by recording the live, streamed video-audio data forming the broadcast corresponding to the user desired show (live event). The working server may cache the video-audio data in cache storage. The cache storage subsystem overwrites or expires cached video-audio data as a function of at least (i) the corresponding show viewed longest ago by the user and/or (ii) the least recently recorded broadcast event. The working server further provides a searchable index to the cached data. The searchable index preferably includes header information from the respective original broadcasts, a summary of each corresponding show having its data cached and indications of user preference for saving or deleting each piece of cached data when the cache storage is full. The working server may receive requests for the same broadcast content from several different users. Preferably the working server stores/caches the corresponding video-audio data for longer periods of time as a function of user demand.

The video-audio output means receives recorded video-audio data from the working server to provide user viewing (playback of a desired corresponding show time shifted from the original live broadcast of the show). The video-audio output means may include a computer, a television, a video cassette recorder and the like. The working server recording and storage and the video-output means may be local to or remote from each other in the network. In the case where the working server is an ISP (service provider) or remote third party, the video-audio data is recorded at a network site remote from the output means. Some of the video-audio data may also be recorded locally to the output means. In that case, a synchronizing means is employed to synchronize playback between the local and remove recordings in a manner transparent to the user.

The invention method carries out the foregoing functions and operations, preferably by computer implemented steps.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an overview of a computer network environment in which the present invention is employed.

FIG. 2 is a schematic diagram of data flow during user request for recording in the present invention.

FIG. 3 is a schematic diagram of data flow during user selection of recorded material in the present invention.

FIGS. 4 and 5 are schematic illustrations of the user interface employed in the preferred embodiment.

### DETAILED DESCRIPTION OF THE INVENTION

A description of preferred embodiments of the invention follows.

The invention is a client server software application, supported by a service allowing users access to a comprehensive index of live multimedia events on the Internet, complete with URL's, start and end times, and frequency of recurrence in a format the application can use to schedule its captures.

The server application captures streaming video formats—examples are the RealNetworks formats (G2, RealVideo, RealAudio) and Microsoft's ASF. It can start and stop recording at specified times from a given URL. In addition, it includes methods for dealing with inexact start and end times: polling a stream to sense when it goes live, and recording a stream until it goes dead.

The system is designed in a client server fashion. The server side receives and stores the content and serves up the time-shifted audio/video to the client on demand. With multiple computers on one high-bandwidth network, the server could serve multiple clients receiving content on demand. Clients need not all run on PC's; a client could be written for a TV set-top box to allow it to receive time-shifted content from a server located on the same home network, or elsewhere on a broadband network connected to the home. The use of standard protocols allows a variety of heterogeneous client platforms to function within the system, requiring only that the client platform run a Web browser and the invention software and, optionally, the Windows Media Player.

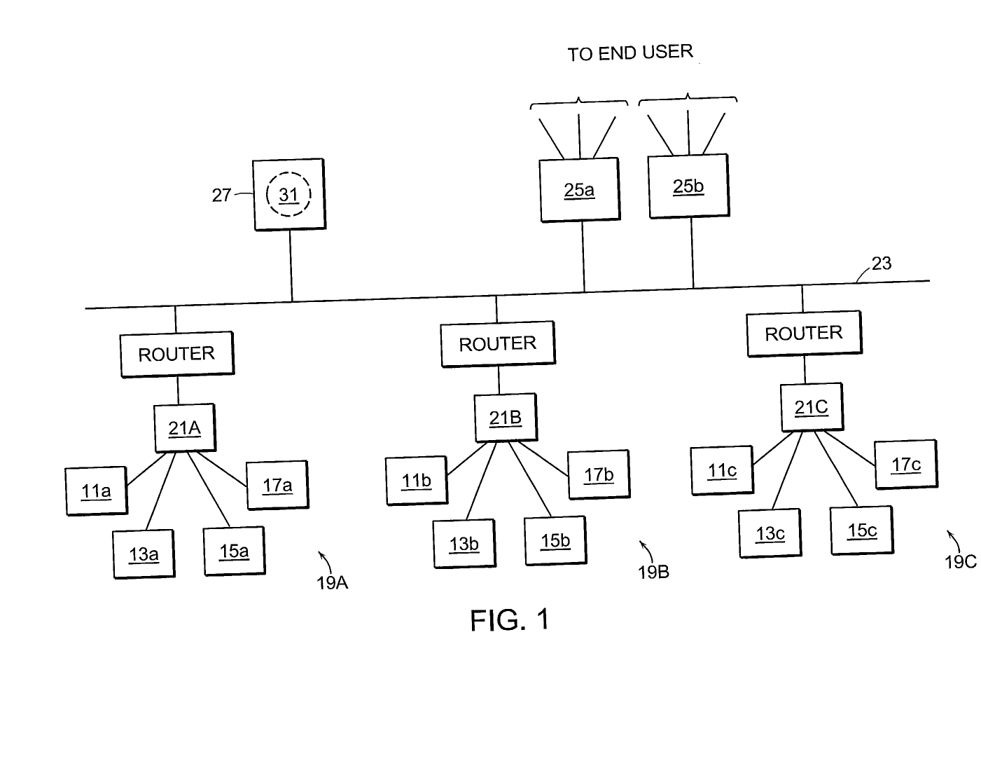

In more specific terms, the preferred embodiment is now described with reference to FIGS. 1-3. Illustrated in FIG. 1 is a plurality of networks 19a, 19b, 19c. Each network 19 includes a multiplicity of digital processors 11, 13, 15, 17 (e.g., PC's, mini computers and the like) loosely coupled to a host processor or server 21a, 21b, 21c for communication among the processors within that network 19. Also included in each network 19 are printers, facsimiles and the like. In turn, each host processor 21 is coupled to a communication line 23 which interconnects or links the networks 19a, 19b, 19c to each other to form an internet. That is, each of the networks 19 are themselves loosely coupled along a communication line 23 to enable access from a digital processor 11, 13, 15, 17 of one network 19 to a digital processor 11, 13, 15, 17 of another network 19. In the preferred embodiment, the loose coupling of networks 19 is the Internet.

Also linked to communication line 23 are various servers 25a, 25b which provide to end users access to the Internet (i.e., access to potentially all other networks 19, and hence processors 11, 13, 15, 17 connected to the Internet). The present invention is a software program 31 operated on and connected through a server 27 to the Internet for communication among the various networks 19 and/or processors 11, 13, 15, 17 and other end users connected through respective servers 25. In the preferred embodiment, the server 27 is a Digital Equipment Corp. Alpha server cluster (e.g., 2400-8000 Series), or a multiplicity of similar such servers. Server 27 runs Oracle 2.0 Webserver as HyperText Transfer Protocol (HTTP) server software to support operation of present invention program 31.

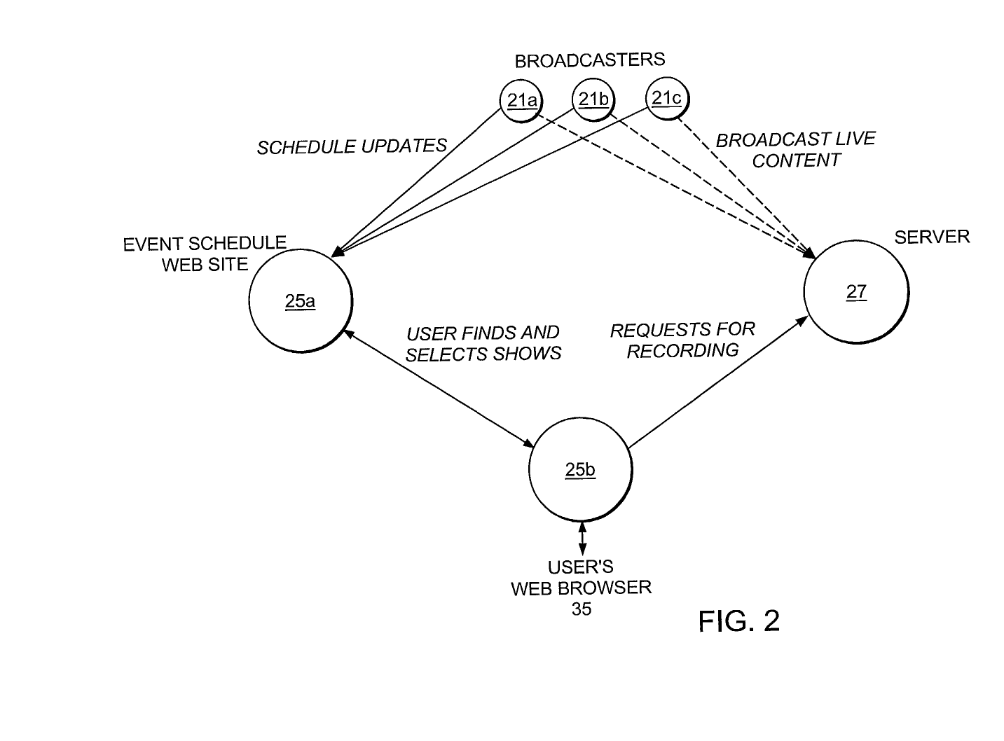

As illustrated in FIG. 2, an end user through a Web browser at server 25b logs onto invention program and Website 31 (running on hosting server 27) to make a request for recording a desired broadcast show. In preparation of making this request, the end user has viewed a listing of live events or shows scheduled to be broadcast over the global network of networks 19 by various broadcasters (network servers) 21 a,b,c. Such a listing is displayed or otherwise obtained through an event schedule Website 25a, for example, that the end user has previously logged onto and obtained show title/name, date, time, URL (universal resource locator) and the like of such desired broadcasts. Event schedule Website 25a maybe, for example, Yahoo! Net Events and OnNow.com. which receive schedule updates from broadcasting servers 21 a,b,c.

The invention client user interface, displayed in the Web browser at 25b, allows the user to specify shows to be recorded in the future, either by selecting individual shows or by creating rules for more than one (e.g., by matching keywords) or recurring shows to be captured. In the preferred embodiment, a centralized service and Web site 31 collects a calendar of events and presents it to the users, to prompt users to make requests for recording desired broadcast shows. In response to user input and selection, the Website/invention program 31 delivers the resulting rule sets specifying live shows to be broadcast over the network by servers 21a,b,c to be captured to (recorded by) the server 27.

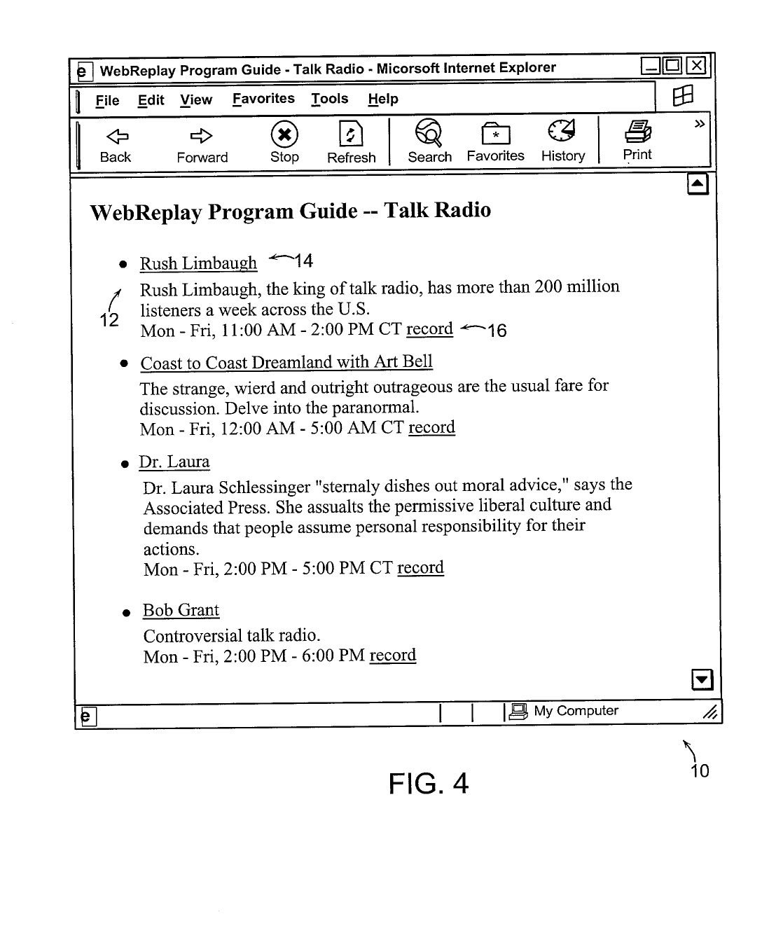

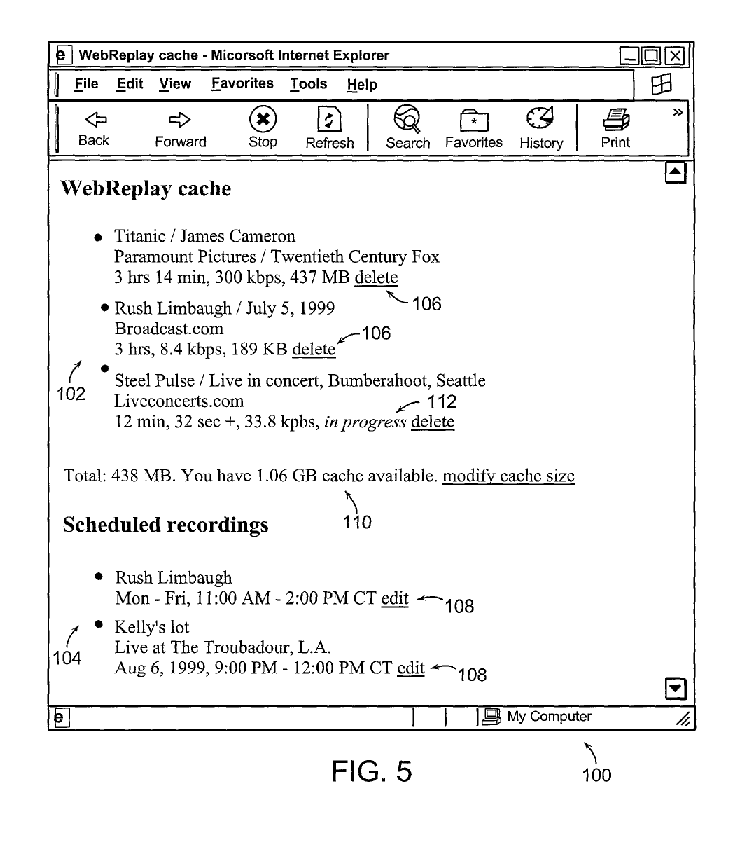

An example of the client user interface (screen view 10) for making a request for recording desired broadcast shows is shown in FIG. 4. Screen view 10 shows a schedule of broadcasts, ordered by date and time, for which the invention program 31 may be set to capture and record. For each scheduled broadcast event, screen view 10 displays the show title or event name 14, a short description 12 of the show or program and date and time of scheduled broadcast. Also command indicators 108 (FIG. 5), 16 are shown illuminated next to each scheduled broadcast/show and serve as prompts or selections that the user may act on through screen view 10. If the user selects the “record” indicator 16 of a listed broadcast show, the invention program 31 schedules the corresponding broadcast (content thereof) for capture (recording) and changes the “record” indicator 16 to an “edit” indicator 108 (FIG. 5). If the user selects an “edit” indicator 108 in screen view 10, invention program 31 enables the user to change (or unschedule) the scheduled recording of the corresponding broadcast.

Where multiple users over time log on to invention Website 31 and make requests for the same broadcast show, server 27 maintains certain heuristics. Based on these heuristics, server 27 may treat certain broadcast contents as in higher user demand relative to other user-requested broadcast contents. Server 27 may store the higher user-demand broadcast contents for longer periods of time than other broadcast contents as discussed below.

After the user has requested and scheduled the recording of desired broadcast shows/events, the invention program 31 appropriately captures the subject broadcasts. That is, the broadcasts are in the form of live streamed video and audio data from various broadcasting servers 21a,b,c. Invention program 31 receives this data and records it, hence the corresponding user-requested broadcast shows, on server 27. In the preferred embodiment, the recorded video-audio data and hence corresponding broadcast shows are cached in a cache storage subsystem 39 of host server 27.

The server cache 39 requires a significant amount of disk space to store video, but the needs are well within what can be supplied by a PC. One hour of a typical 60 kbps video requires 22 MB of storage; an hour of higher quality 300 kbps video requires 132 MB.

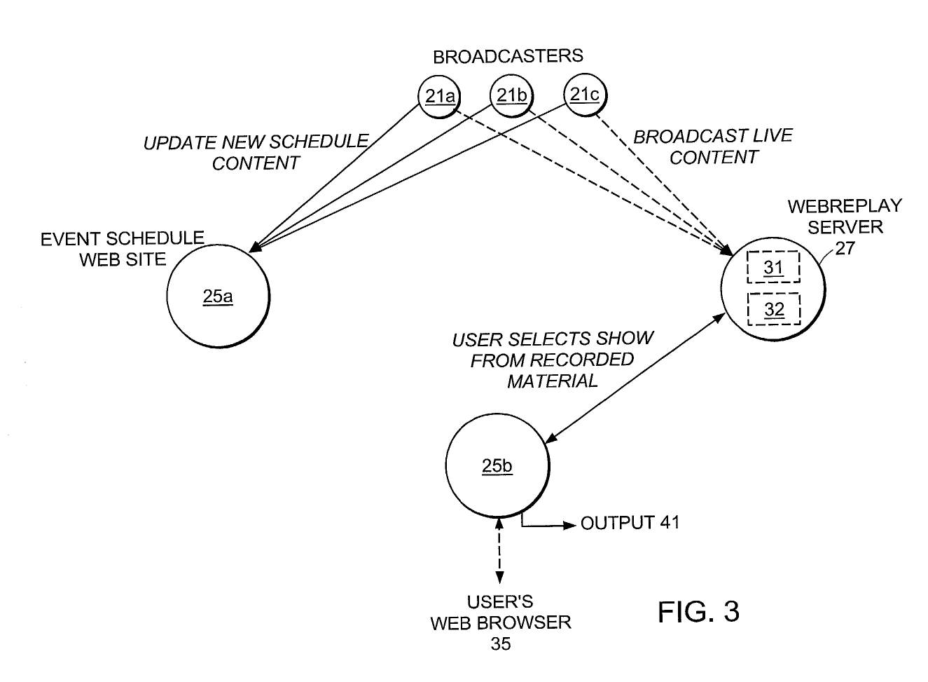

Subsequently, the user logs onto invention Website 31 to make a selection from the captured and recorded broadcasts (shows) as illustrated in FIG. 3. Upon user selection and command, program 31 provides the desired recorded video-audio data to support display or rendering (playback) of the corresponding broadcast show through output means 41 at the user server 25b. The output means 41 includes any combination of a television, VCR (video cassette recorder) unit and PC/computer and similar monitors and sound systems. In this manner, the present invention 31 provides a method and means for providing desired live broadcasts in a time shifted (delayed from original broadcasting) manner. Recording and playback overlap if the recording is time shifted by less than the show's or event's duration.

The client user interface (rendered through the user's Web browser 35) allows the user to search and browse the captured shows to find those of interest and to delete those that are no longer of interest. Rules may be imposed by the user to manage the cache 39. These rules indicate which archived shows should be marked to prevent new shows from being recorded over them. As new shows are recorded, the preferred default expiration policy is to delete the least recently recorded and/or the show longest ago viewed by the user, with the exception of shows marked to prevent deletion or in user demand. User demand may be determined by the number of requests to capture the subject broadcast show as well as the continuing or repeated viewing/replay of the recorded show. The cache 39 lives on and is ultimately managed by the server 27.

Alternatively, the subject broadcast show content may be archived locally on the user's PC 25b; in that case the invention server part of program 31 runs locally and may serve only one client or a small number of clients on a local area network (e.g., other PC's or set-top boxes). Yet in another alternative, the content may be archived by a third party service, for example, one served by the user's (broadband) Internet Service Provider (ISP). In that case server 25b in FIG. 3 is an ISP server. To make the best use of the disk space available to the overall system, a shared server 25b would maintain only one copy of shows requested by multiple clients. In such a case, shows are reference-counted by the server 25b to keep track of when they can be deleted and overwritten. Conceivably, the content may be archived on both a remote server (ISP server 25) and locally (e.g., user PC 25b), with policies about which programs to store in each location—more popular ones might be archived by the ISP, leaving users to archive the less popular ones themselves. In that case, the two invention archive modules/members synchronize in order to maintain the invention service 31 transparently to the end user.

The archived shows have an index that makes it easy for the user to inspect the contents of the cache, delete unwanted shows and mark/unmark shows to prevent/allow their deletion when the cache 39 is filled. The index is a searchable one, containing information provided by the invention service 31, header information from the show itself, if available, and possibly other information. Thumbnail summaries are created of the videos in the cache 39 to display to the user. An example of the user interface for selecting and caching recorded material is shown in FIG. 5.

Illustrated in FIG. 5 is an index screen view 100 of the cache 39 of broadcasts recorded (or being recorded) by invention program 31. The contents of the cache 39 are indicated at 102 by title of the show or event, date (as needed) and broadcaster/source. Also indicated is the length (in time) and size (occupied memory space) of each recorded broadcast. Those recordings that are in progress 112 have current length and size indicated as well as the fact that the recording is currently continuing.

Per user interaction with cache index screen view 100, certain ones of the recorded broadcasts are marked for deletion 106 as shown in FIG. 5. Similarly, the user may mark certain ones for saving. Further the available space in cache 39 is indicated as at 110 in FIG. 5.

As in the purview of one skilled in the art, index screen view 100 may also display an indication of where the recording is stored/cached (local or remote). Other indications are similarly suitable and in the purview of the skilled artisan.

The lower portion of cache index screen view 100 provides a summary section 104 of broadcasts currently scheduled for recording. These are the shows that were previously selected by a user through the program guide screen view 10 of FIG. 4, for capture and recording. Alternatively (as previously mentioned), the same information may also be displayed in the program guide screen view 10 of FIG. 4.

The “scheduled recording” summary section 104 is very important from the server 27 point of view because the content providers are enabled to know in advance who and how many people are interested in their broadcast shows. This information may then be used to sell commercials, and eventually better target the audience. Also, if the number of requests is too low, the broadcast show (contents) may be recorded locally rather than by the server 27.

While this invention has been particularly shown and described with references to preferred embodiments thereof, it will be understood by those skilled in the art that various changes in form and details may be made therein without departing from the scope of the invention encompassed by the appended claims.

Broadcasters might get uncomfortable about allowing their content to be saved if it could be easily redistributed—attempting to prevent redistribution could be one of the reasons for them to decide to only broadcast their content live. Broadcasters' cooperation is not needed to create or use the present invention 31. Another embodiment of the invention only allows content to be saved to disk that is specially marked by the content provider. Typically network broadcast shows do not have this mark set. A way to appease content providers is to maintain the cache 39 data in an obscure or encrypted format and to provide no options from the invention application 31 for the end user to locally save the corresponding show.

Also a local archive may be indexed for convenient later retrieval, by stripping captions from documents that can support them (see the SMIL standard at http://www.w3c.org, adhered to by the RealNetworks G2 format), using speech recognition or any other method of content based retrieval.

What is claimed is:

1. In a global computer network having at least one node broadcasting live events over the network, a method of providing to a user desired ones of said live broadcasts shifted in time comprising the computer-implemented steps of:
receiving from a user a request for content of the broadcast of at least one certain future event, the request indicating date, time and network location of respective broadcasts of each requested event;
recording at a working server, the respective broadcast of each requested event according to the date, time and network location indicated in the request, each broadcast being in the form of live streamed video-audio data over the network such that said recording records corresponding streamed video-audio data of the respective broadcast of each requested event; and
upon user command to view a certain one of the requested events, providing the recorded streamed video-audio data corresponding to said certain one of the requested events to a digital player for user viewing therefrom, said viewing being in a manner time shifted from original broadcast of the certain one of the requested events.

2. A method as claimed in claim 1 further comprising the step of providing a schedule of events to be broadcast live over the network, the schedule enabling the user to formulate a request.

3. A method as claimed in claim 1 wherein the working server and digital player are local to each other in the network such that the step of recording at the working server includes recording local to the digital player.

4. A method as claimed in claim 1 wherein the working server is at a third party site in the network remote from the digital player, such that the step of recording includes recording at a network site remote from the digital player.

5. A method as claimed in claim 4 wherein the step of recording includes recording some of the respective broadcasts locally to the digital player and recording different ones of the respective broadcasts remotely from the digital player; and
further comprising the step of synchronizing between the local and remote recordings such that the step of providing the recorded streamed video-audio data is supported by both local and remote recordings in a manner transparent to the user.

6. A method as claimed in claim 1 wherein the step of recording includes caching to cache storage, the streamed video-audio data corresponding to the respective broadcasts of the requested events.

7. A method as claimed in claim 6 wherein the step of caching includes overwriting the streamed video-audio data in the cache storage corresponding to one of (i) the event viewed longest ago by the user and (ii) the least recent broadcast event.

8. A method as claimed in claim 6 wherein the step of caching includes providing a searchable index to the streamed video-audio data in the cache storage.

9. A method as claimed in claim 8 wherein the step of providing a searchable index includes providing in the index, header information from respective original broadcasts.

10. A method as claimed in claim 8 wherein the step of providing a searchable index includes for each streamed video-audio data in the cache storage, providing interface means for enabling the user to indicate preference for saving or deleting the streamed video-audio data when the cache storage is full.

11. A method as claimed in claim 6 further comprising the step of for each streamed video-audio data in the cache storage, providing a respective summary of the corresponding event, said summary being displayable to the user.

12. A method as claimed in claim 1 further comprising the step of scheduling broadcasts to be recorded across multiple users and their requests.

13. A method as claimed in claim 12 wherein the step of recording includes storing the streamed video-audio data corresponding to respective broadcasts for a length of time determined according to user demand across the multiple users.

14. In a global computer network having at least one node broadcasting live events over the network, apparatus for providing to a user contents of desired ones of said broadcasts shifted in time, comprising:
user interface means for enabling a user to form a request for contents of desired broadcasts of future live events, said request including date, time and network location of each desired broadcast;
a working server coupled to the user interface means to receive requests formed by users, the working server recording the respective broadcast of each requested event according to date, time and network location indicated in the request, each broadcast being in the form of live streamed video-audio data over the network, such that the working server records corresponding streamed video-audio data of the respective broadcast of each requested event; and
video-audio output means coupled to receive the recorded streamed video-audio data from the working server, such that upon user command to view a certain one of the requested events, the video-audio output means provides respective broadcast contents from the recorded streamed video-audio data for user viewing of the certain requested event, in a manner time shifted from time of original broadcast of the certain requested event.

15. Apparatus as claimed in claim 14 further comprising a schedule source providing a schedule of events to be broadcast live over the network, the schedule enabling the user to formulate a request.

16. Apparatus as claimed in claim 14 wherein the working server and video-audio output means are local to each other in the network such that the working server records local to the video-audio output means.

17. Apparatus as claimed in claim 14 wherein the working server is at a third party site in the network remote from the video-audio output means, such that the working server records at a network site remote from the video-audio output means.

18. Apparatus as claimed in claim 17 wherein the working server records some of the respective broadcasts locally to the video-audio output means and records different ones of the respective broadcasts remotely from the video-audio output means, and
further comprising a synchronizer coupled to the video-audio output means for synchronizing between the local and remote recordings, such that the video-audio output means is supported by both local and remote recordings in a manner transparent to the user.

19. Apparatus as claimed in claim 14 further comprising a caching system including a cache storage for caching the streamed video-audio data corresponding to respective broadcasts of the requested events recorded by the working server.

20. Apparatus as claimed in claim 19 wherein the cache system overwrites the streamed video-audio data in the cache storage corresponding to one of (i) the event viewed longest ago by the user and (ii) the least recent broadcast event.

21. Apparatus as claimed in claim 19 wherein the caching system provides a searchable index to the streamed video-audio data in the cache storage.

22. Apparatus as claimed in claim 21 wherein the searchable index includes header information from the respective original broadcast.

23. Apparatus as claimed in claim 21 wherein the searchable index includes interface means for enabling the user to indicate preference for saving or deleting the streamed video-audio data when the cache storage is full.

24. Apparatus as claimed in claim 19 wherein the cache system includes for each streamed video-audio data in the cache storage a respective summary of the corresponding event, said summary being displayable to the user.

25. Apparatus as claimed in claim 14 further comprising a scheduler coupled to the working server, the scheduler scheduling broadcasts to be recorded across multiple users and their requests.

26. Apparatus as claimed in claim 25 wherein the working server further stores the streamed video-audio data corresponding to respective broadcasts for a length of time determined according to user demand across multiple users.

27. Apparatus as claimed in claim 14 wherein the video-audio output means includes one of a television, a computer system and a video cassette recorder.

28. A method for providing broadcast data shifted in time comprising the computer implemented steps of:
receiving requests from users to record respective desired broadcast programs;
recording streamed multimedia data forming the respective desired broadcast programs; and
using the recorded streamed multimedia data, enabling user viewing of a corresponding broadcast program at a time subsequent to original broadcasting of said program.

29. A method as claimed in claim 28 wherein the step of recording includes storing by caching.

30. A method as claimed in claim 29 wherein said caching overwrites and saves streamed multimedia data as a function of number of user requests for the corresponding broadcast program.

31. A method as claimed in claim 28 wherein the step of enabling user viewing includes supporting a multimedia rendering of the corresponding desired broadcast program through one of a television, computer system and video cassette recorder.
